(19) United States
(12) Patent Application Publication
(10) Pub. No.: US 2002/0033579 A1
(43) Pub. Date: Mar. 21, 2002

(54) PISTON RING

(75) Inventor: MASAO ISHIDA, NAGANO-KEN (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: TEIKOKU PISTON RING CO.LTD

(21) Appl. No.: 09/454,995

(22) Filed: Dec. 6, 1999

(30) Foreign Application Priority Data
Dec. 8, 1998 (JP) 10-366085

(51) Int. Cl. F02F 5/00

(52) U.S. Cl. 277/434

(57) ABSTRACT

The outer circumferential surface of a second ring is comprised of an outer circumferential surface with a taper face having an outer diameter that increases towards the downward direction, and an outer circumferential surface having the same outer diameter and extending slightly in a perpendicular direction from the lower edge of the taper-faced outer circumferential surface. An annular groove is formed near the outer circumference on a lower surface of the second ring. The annular groove is formed along the entire circumference of the ring and is open at end surfaces of the ring. The annular groove is open to a space between the third land of a piston and the inner circumferential surface of a cylinder.

### BACKGROUND OF THE INVENTION

1. Technical Field of the Invention

The present invention relates to a piston ring used in internal combustion engines.

2. Description of the Related Art

The second ring mounted on pistons in internal combustion engines is typically formed with a taper face shape on the outer circumferential surface in order to assure an oil-scraping effect. Methods are known in the conventional art for improving the oil-scraping effect by means of a scraper ring 21 formed with a notch 20 in a step shape on the lower side of the outer circumference of the ring as shown in FIG. 3A, and by means of a napier ring 23 with an oblique notch 22 in an undercut step shape on the lower side of the outer circumference of the ring as shown in FIG. 3B.

Forming piston rings with the notches 20 and 22 with a step shape or undercut step shape has the effect of lowering lubricant oil consumption. This lower lubricant oil consumption is explained by the following reasons.

Firstly, forming a piston ring with a notch on the lower side of the outer circumference increases the dimensions of the space formed by the third land between the second ring groove and the oil ring groove of the piston, the cylinder inner circumferential surface, the second ring and the oil ring.

Secondly, the space at the third land serves as a collection room for scraped oil, thus increasing the oil-scraping effect.

Thirdly, the space at the third land relieves the pressure at the area of the second land between the top ring groove and the second ring groove. This causes the pressure at the second land area to decline, so that the reverse flow of lubricant oil from the second land portion to the combustion chamber does not occur and the consumption of lubricant oil therefore decreases.

However, when the notch is formed on the lower side of the outer circumference of a thin-width piston ring having an outer circumferential surface with a taper face, the radial width of the taper section on the outer circumferential surface becomes narrow. Thus, forming a notch shortens the time required for the taper section to disappear due to wear, and the oil-scraping effect cannot be adequately maintained for a long period of time.

### SUMMARY OF THE INVENTION

The present invention has an object of providing a piston ring with a taper face on the outer circumferential surface and capable of maintaining a high oil-scraping effect for a long period of time.

A piston ring of the present invention having an outer circumferential surface with a taper face having an outer diameter that increases towards the downward direction is fitted in the ring groove of the piston inserted into the cylinder, and the piston ring is characterized in that an annular groove is formed on the lower surface of said piston ring, and is open to a space between the inner circumferential surface of the cylinder and the outer circumferential surface of the piston.

### BRIEF DESCRIPTION OF THE DRAWINGS

FIGS. 1A and 1B show one embodiment of the present invention. FIG. 1A is a vertical cross-sectional view showing a second ring mounted on a piston inserted into a cylinder. FIG. 1B is a bottom view of the second ring.

FIGS. 2A and 2B show another embodiment of the present invention. FIG. 2A is a vertical cross-sectional view showing a second ring mounted on a piston inserted into a cylinder. FIG. 2B is a bottom view of the second ring.

FIGS. 3A and 3B show piston rings known in the conventional art. FIG. 3A is a vertical cross-sectional view showing a scraper ring. FIG. 3B is a vertical cross-sectional view showing a napier ring.

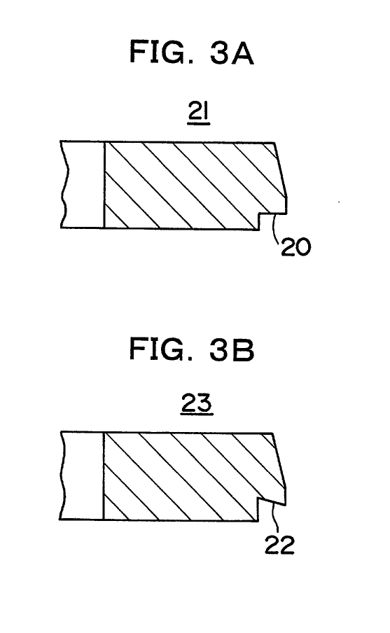

### DETAILED DESCRIPTION OF THE PREFERRED EMBODIMENTS

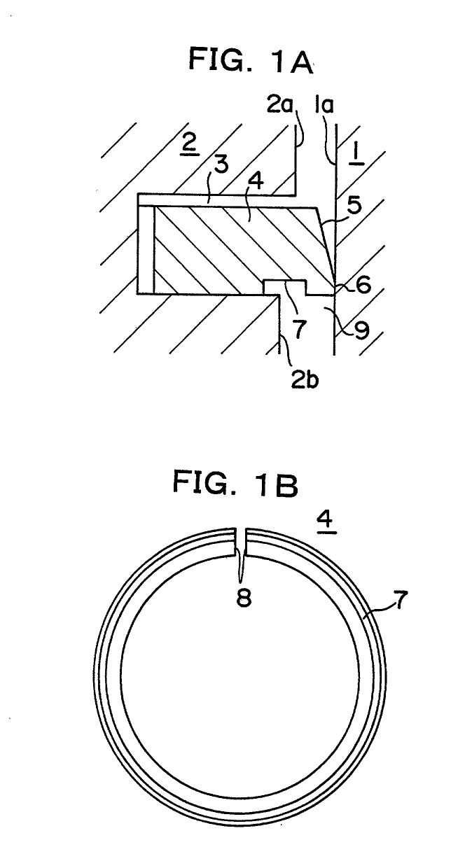

Hereafter, one preferred embodiment of the present invention is described while referring to FIG. 1A and FIG. 1B.

The reference numeral 1 denotes a cylinder, the reference numeral 2 denotes a piston inserted into the cylinder 1, and a top ring, second ring, and oil ring are respectively fitted in the three ring grooves formed on the outer circumferential surface of the piston 2. The figures show the second ring 4 fitted in the second ring groove 3 of the piston 2. The third land 2b between the ring groove 3 for the second ring 4 and the oil ring groove located below the ring groove 3 in the piston 2 is formed with a smaller outer diameter than the second land 2a between the ring groove for the top ring and the ring groove 3 for the second ring 4.

The outer circumferential surface of the second ring 4 is comprised of an outer circumferential surface 5 with a taper face having an outer diameter that increases towards the downward direction, and an outer circumferential surface 6 having the same outer diameter and extending slightly in a perpendicular direction from the lower edge of the taper-faced outer circumferential surface 5. An annular groove 7 is formed near the outer circumference on the lower surface of the second ring 4. The annular groove 7 is formed along the entire circumference of the ring and is open at end surfaces 8 of the ring. The annular groove 7 is open to a space 9 between the third land 2b of the piston 2 and the inner circumferential surface 1a of the cylinder 1. The cross section of the annular groove 7 is shown as a rectangle in the figure, however the annular groove 7 is not limited to this shape and may for instance be a semicircle or a triangle shape, etc. Besides forming the annular groove 7 by machining with machine tools, the annular groove 7 may also be formed in a production process of the ring wire material.

There are no special restrictions on the ring material and surface treatment when making the second ring 4. Therefore, the second ring 4 can be made of conventional materials such as cast iron, steel or stainless steel, etc. The surface treatment process for the outer circumferential surface of the second ring 4 can use conventional chromium plating, gas nitriding, or physical vapor deposition processes or alternatively, the outer circumferential surface can be used as is, without no processing.

The dimensions of the second ring 4 are listed next. The dimensions and positions of the annular groove 7 are determined by the interrelation of the second ring 4, the cylinder 1 and the piston 2.

| | |
|---|---|
| Ring radial thickness: | 1.0 to 10.0 mm |
| Ring axial width: | 0.5 to 3.0 mm |
| Taper angle of taper-faced outer | 30 to 180 minutes |
| circumferential surface 5: | |
| Axial width of perpendicular | 0.05 to 1.5 mm |
| outer circumferential surface 6: | |
| Axial depth of annular groove 7: | 0.1 to 0.8 mm |
| | (preferably a range |
| | of 0.2 to 0.6 mm) |
| Radial width of annular groove 7: | 0.2 to 0.8 mm |
| | (preferably a range |
| | of 0.3 to 0.6 mm) |
| Distance between outer circumferential | 0.1 to 1.0 mm (preferably |
| edge of annular groove 7 | a range of 0.3 to 0.5 mm) |
| and perpendicular outer | |
| circumferential surface 6: | |

The second ring 4 reduces the amount of lubricant oil consumption. More specifically, the annular groove 7 at the bottom of the second ring 4 increases the dimensions of the space formed by the third land 2b of the piston 2, the cylinder inner circumferential surface 1a, the second ring 4 and the oil ring fitted in the oil ring groove. The space at the third land 2b serves as a collection room for oil scraped by the second ring 4, thus increasing the oil-scraping effect. The space at the third land 2b relieves the pressure at the area of the second land 2a and the pressure at the second land area declines, so that the reverse flow of lubricant oil from the second land portion to the combustion chamber does not occur and the consumption of lubricant oil therefore decreases.

Also, the radial width of the taper-faced outer circumferential surface 5 does not become narrow even if the annular groove 7 is formed at the lower surface of the second ring 4. Accordingly, a satisfactory oil-scraping effect can be maintained for a long time, since the time required for the taper section to disappear due to wear does not shorten.

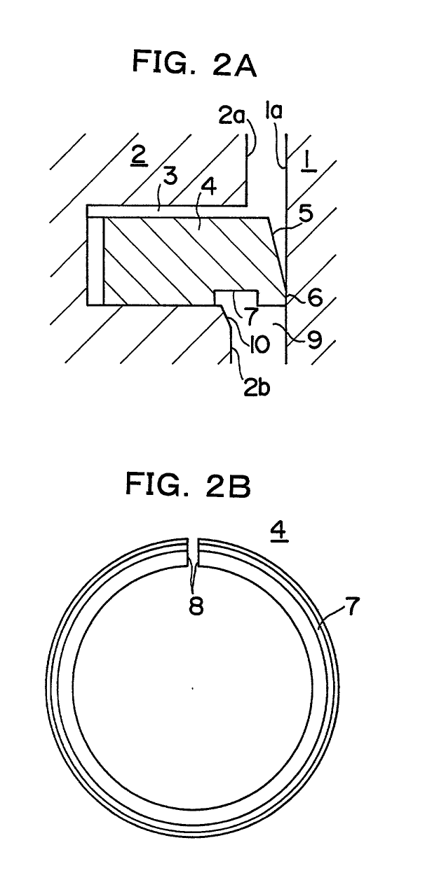

Another preferred embodiment of the present invention is shown in FIG. 2A and FIG. 2B. The point where this embodiment differs from the above described embodiment is that a chamfer 10 is formed at the corner of the second ring groove side of the third land 2b of the piston 2. The chamfer 10 further increases the dimensions of the space formed by the third land 2b of the piston 2, the cylinder inner circumferential surface 1a, the second ring 4 and the oil ring, which increases the oil-scraping effect.

Although the present invention has been described with reference to the preferred embodiments, it is apparent that the present invention is not limited to the aforesaid preferred embodiments, but various modification can be attained without departing from its scope.

What is claimed is:

1. A piston ring having an outer circumferential surface with a taper face having an outer diameter that increases toward the downward direction, and fitted in a ring groove of a piston inserted into a cylinder, wherein said piston ring has an annular groove formed on a lower surface of said piston ring, and said annular groove is open to a space between an inner circumferential surface of said cylinder and an outer circumferential surface of said piston.

2. A piston ring as claimed in claim 1, wherein said piston ring is a second ring.

3. A piston ring as claimed in claim 2, wherein said annular groove has an axial depth of 0.1 to 0.8 millimeters and a radial width of 0.2 to 0.8 millimeters.

4. A piston ring as claimed in claim 2, wherein said annular groove has a rectangular, semi-circular or triangular cross-sectional shape.
